(19) United States
(12) Patent Application Publication
(10) Pub. No.: US 2011/0113362 A1
(43) Pub. Date: May 12, 2011

(54) MOBILE COMMUNICATION APPARATUS WITH TOUCH INTERFACE, AND METHOD AND COMPUTER PROGRAM THEREFORE

(75) Inventors: Yuichi KATO, Malmo (SE); Wayne MINTON, Lund (SE); Par STENBERG, Veberod (SE)

(73) Assignee: Sony Ericsson Mobile Communications AB, Lund (SE)

(21) Appl. No.: 12/616,427

(22) Filed: Nov. 11, 2009

(51) Int. Cl. G06F 3/041; G08B 3/00; G10L 21/00; G06F 3/048; G06F 3/033

(52) U.S. Cl. 715/784; 340/384.1; 345/173; 704/275; 455/566; 704/E15.04; 715/863

(57) ABSTRACT

A mobile communication apparatus having a reduced user interface is disclosed. The apparatus comprises a touch sensitive input arranged to receive touch actions on a primary surface of the mobile communication apparatus, wherein interpretation of touch actions as input is independent on position of touch on the primary surface while being depending on the way of the touch action, and an output arranged to provide an audio feedback of a user interface status from the interpreted input of the touch actions.

### TECHNICAL FIELD

The present invention relates to a mobile communication apparatus, a method therefore, and a computer program product.

### BACKGROUND

Operating mobile communication apparatuses raises different issues. A small form factor, a multitude of features, and demands that the apparatus should be able to operate in any situation is a cumbersome task for anyone who is to design a user interface. Dedicated keys or buttons have limitations as functions and input options increase. Touch screens and so called soft keys have been introduced to increase versatility. However, the latter approach, although enabling the increased versatility, have introduces limitations with respect to the ability to operate the apparatus in any situation. It is therefore a need to provide a different approach for operating mobile communication apparatuses.

### SUMMARY

The present invention is based on the understanding that operation of a mobile communication apparatus where the user does not have to look at the apparatus can have several advantages. The inventors have found that making touch position independent on absolute position, and instead interpreting the way touch actions are made can greatly improve operability of a mobile communication apparatus.

According to a first aspect, there is provided a mobile communication apparatus having a reduced user interface comprising a touch sensitive input arranged to receive touch actions on a primary surface of the mobile communication apparatus, wherein interpretation of touch actions as input is independent on position of touch on the primary surface while being depending on the way of the touch action; and an output arranged to provide an audio feedback of a user interface status from the interpreted input of the touch actions.

The output can further comprise a display, wherein the area of the primary surface for receiving touch actions is larger than an area of the display and covers the area of the display. The display can be arranged such that, when in an off-state, the boundaries of the display area is essentially invisible on the surface of the mobile communication apparatus, and when in an on-state, content viewed on the display is faded towards the boundaries of the display such that the boundaries of the display area is hard to perceive. The display can additionally or alternatively be arranged to, upon input of a touch action comprising a sweeping movement touch point to be interpreted as a scroll action, initially scroll content displayed on the screen in a direction opposite to the sweeping movement, and finally to scroll the content in a direction of the sweeping movement.

A touch action comprising one static touch point can be interpreted as a selection input. A touch action comprising two static touch points can be interpreted as a back input. A sweeping movement touch point can be interpreted as a scroll input. The scroll input can enable different items for selection.

The touch sensitive input can further comprise a secondary surface. The secondary surface can comprise one or more sub-surfaces. The one or more sub-surfaces each can be essentially perpendicular to the primary surface. A touch action on the primary surface or any of the sub-surfaces, or a combination of touch actions on the primary surface and any of the sub-surfaces, or a combination of touch actions on at least two of the sub-surfaces can be interpreted according to the surface or surfaces of the touch action or actions, respectively. A combination of touch actions on two of the sub-surfaces being arranged essentially in parallel can be interpreted as a voice command activation input. A touch action comprising a sweeping movement touch point on one of the sub-surfaces can be interpreted as a level setting input, such as audio volume, backlight intensity, or ringtone volume.

Any combination of touch action sets are feasible and selectable upon design of the touch user interface.

The apparatus can be arranged such that tactile input means of the apparatus consists of the touch sensitive input.

According to a second aspect, there is provided a method for a reduced user interface for a mobile communication apparatus. The method comprises receiving at least one touch action on a primary surface of the mobile communication apparatus by a touch sensitive input; interpreting the at least one touch action independent on position of touch on the primary surface while depending on the way of the at least one touch action; and providing an audio feedback of a user interface status from the interpreted input of the at least one touch action.

For the interpreting of the touch action, interpretation can be made according to what is demonstrated for the first aspect.

The touch sensitive input can further comprise a secondary surface comprising one or more sub-surfaces, wherein the one or more sub-surfaces each are essentially perpendicular to the primary surface. The method can thus further comprise interpreting a touch action on the primary surface or any of the sub-surfaces, or a combination of touch actions on the primary surface and any of the sub-surfaces, or a combination of touch actions on at least two of the sub-surfaces according to the surface or surfaces of the touch action or actions, respectively. The method can further comprise interpreting a combination of touch actions on two of the sub-surfaces being arranged essentially in parallel as a voice command activation input. The method can further comprise interpreting a touch action comprising a sweeping movement touch point on one of the sub-surfaces a touch action as a level setting input, such as audio volume, backlight intensity, or ringtone volume.

According to a third aspect, there is provided a computer readable medium comprising program code with instructions arranged to be executed by a processor of a mobile communication apparatus, wherein the instructions cause the portable electronic device to perform the method according to the second aspect.

### BRIEF DESCRIPTION OF DRAWINGS

FIG. 1 is a block diagram schematically illustrating a mobile communication apparatus according to an embodiment.

FIG. 2 is a flow chart illustrating a method according to an embodiment.

FIG. 3 schematically illustrates a computer program product according to an embodiment.

FIG. 4 illustrates a mobile communication apparatus according to an embodiment.

FIGS. 5 to 10 illustrate examples of touch actions for a mobile communication apparatus according to embodiments.

### DETAILED DESCRIPTION

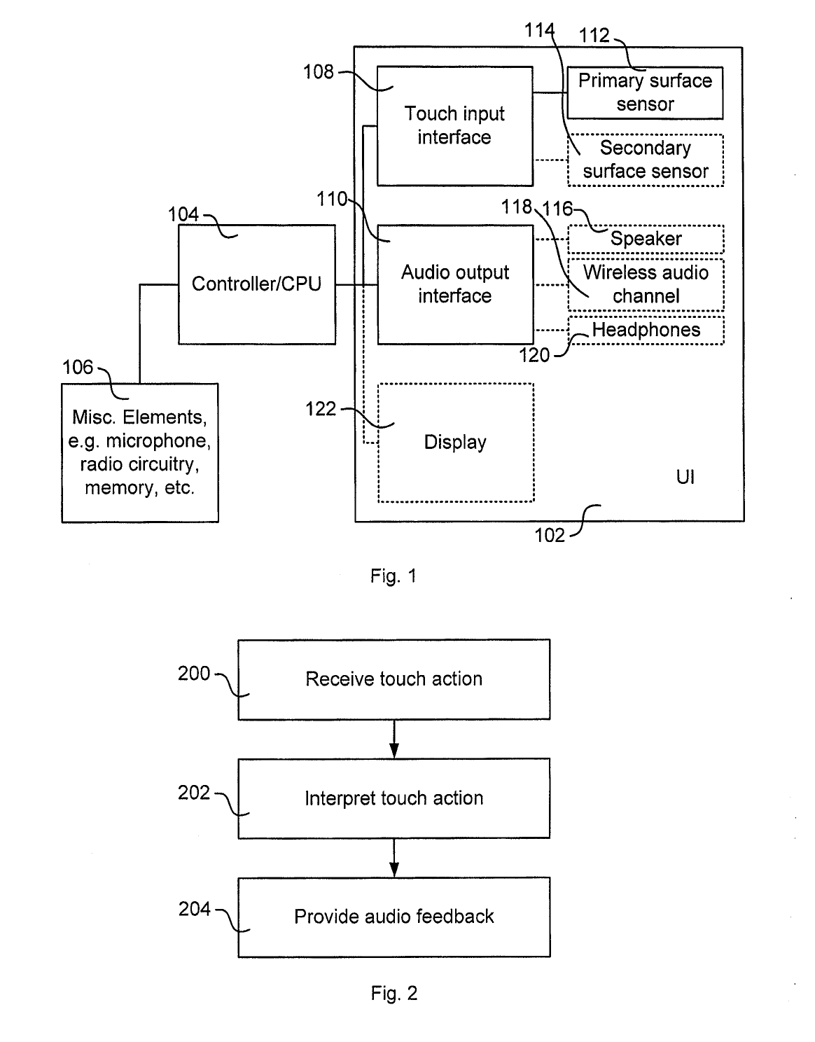

FIG. 1 is a block diagram schematically illustrating a mobile communication apparatus 100 according to an embodiment. The apparatus 100 comprises a user interface (UI) 102, a controller or central processing unit (CPU) 104, and preferably miscellaneous elements 106 such as microphone, radio circuitry, memory, etc. for completing ordinary tasks of a mobile communication apparatus. The miscellaneous elements 106 are well-known features within the area of mobile communication apparatuses and will not be further elucidated here, not to obscure the special features of the mobile communication apparatus 100. The controller or CPU 104 can comprise one or more processors, such as a single processor, a few similar processors arranged in a cluster, or a few processors dedicated for different tasks, respectively, such as central controller and signal processor, video controller and/or communication controller.

The UI 102 comprises a touch input interface 108 and an audio output interface 110. The touch input interface 108 comprises a touch sensitive input element arranged to receive touch actions on at least a primary surface 112, and optionally on a secondary surface 114, of the mobile communication apparatus 100. On one hand, the position of the touch action or actions, depending on whether one or more fingers are involved in the touch action, is/are determined such that a moving touch action can be discriminated from a static touch action. On the other hand, interpretation of the touch action is independent on position of touch on the surface. Thus, the interpretation is depending only on the way of the touch action, i.e. one or more touch points, moving or static, and general direction in the case of moving action. This has for example the advantage that it is not necessary to align touch sensor with for example displayed objects or particular areas of the surface. Only relative positions are for example needed to detect movement of sweeping touch action, and only single or double (triple, etc.) touch needed to be detected to discriminate different touch actions. Thus, absolute position is not necessary to be detected, and the user does not need to look at apparatus for operation. This is particularly advantageous when the user needs to pay attention by looking at other things, or when the user is visually impaired. The general direction can be divided into for example two (e.g. up/down) or four (e.g. up/down/left/right) general directions, wherein the plane of the surface 112 is divided into directions accordingly. Thus, the exact direction is not needed to be performed by the user, which is advantageous when operating the apparatus 100 without looking at it.

To be able to operate the mobile communication apparatus 100 by applying proper touch actions, the user is provided with a user interface status via the audio output interface 110. An audio feedback indicating the user interface status, which is caused by the interpreted input of the touch actions, is provided to the user which then is able to navigate and operate the mobile communication apparatus 100. The audio output interface 110 can provide the audio output via a speaker 116, a wireless audio channel 118 to a wireless headset, speaker or handsfree equipment, or a set of headphones 120.

The use of the demonstrated user interface can eliminate the need for buttons and keys of the mobile communication apparatus 100. Lack of buttons and keys improves mechanical robustness of product. Dust and moisture are easier to keep out of interior of the mobile communication apparatus 100. Further, an improved quality feeling of the product can be achieved, e.g. since there is no risk of rattling keys.

The UI can optionally comprise a display 122. A particular feature can be that the area of the primary surface for receiving touch actions is larger than an area of the display 122 while it covers the area of the display 122. Thus, the touch sensitive area goes beyond the boundaries of the display 122. This provides for several design options. For example, a smaller display can be used, without limiting operability of the mobile communication apparatus, compared to a traditional touch screen. The touch sensitive area can reach all the way to the boundaries of the product instead of the boundaries of the display. The display 122 can be arranged such that, when in an off-state, the boundaries of the display area is essentially invisible on the surface of the mobile communication apparatus 100, and when in an on-state, content viewed on the display can be faded towards the boundaries of the display such that the boundaries of the display area is hard to perceive for the user. This effect is preferably provided by the controller or CPU 104, and by the video controller thereof if one is present. For further user experience, the display can be arranged to, upon input of a touch action comprising a sweeping movement touch point to be interpreted as a scroll action, initially scroll content displayed on the screen in a direction opposite to the sweeping movement, and finally to scroll the content in a direction of the sweeping movement. This effect is preferably also provided by the controller or CPU 104, and by the video controller thereof if one is present. The visual effect to the user is an emphasized scroll movement of the content if the user should look at the display.

A touch action comprising a sweeping movement touch point can be interpreted as a scroll action or indication of increasing/decreasing a parameter, depending on user interface status. The scroll input can enable different items for selection when used for navigating for example a menu structure of the UI 102. A touch action comprising one static touch point can be interpreted as a selection input according to the present user interface status. A touch action comprising two static touch points can be interpreted as a back input when navigating for example a menu structure of the UI 102.

When the touch input interface 108 comprises the secondary surface sensor 114, the secondary surface can comprise one or more sub-surfaces. The one or more sub-surfaces are each essentially perpendicular to the primary surface such that the user is able to clearly distinguish the surfaces from each other without looking at the apparatus 100. A touch action on the primary surface, as elucidated above, or any of the sub-surfaces, is interpreted according to which surface that is actuated. Also a combination of touch actions on the primary surface and any of the sub-surfaces, or a combination of touch actions on at least two of the sub-surfaces can be interpreted according to the surface or surfaces and combination of touch action or actions, respectively. For example, a combination of touch actions on two of the sub-surfaces being arranged essentially in parallel is interpreted as a voice command activation input, or a touch action comprising a sweeping movement touch point on one of the sub-surfaces can be interpreted as a level setting input, such as audio volume, backlight intensity, or ringtone volume.

FIG. 2 is a flow chart schematically illustrating a method according to an embodiment. In a touch action reception step 200, a touch action, i.e. at least one touch action on at least a primary surface, and optionally on a secondary surface, of a mobile communication apparatus, where the position of the touch action or actions, depending on whether one or more fingers are involved in the touch action, is/are determined such that a moving touch action can be discriminated from a static touch action, is received. In an interpretation step 202, the at least one received touch action is interpreted depending on the way of the at least one touch action, i.e. independent on position of touch on the surface. In a feedback step 204, an audio feedback of a user interface status is provided. The user interface status depends on the interpreted input of the at least one touch action, and of course the status before the touch action was received. The

[symbol]

For example, a touch action comprising one static touch point can be interpreted as a selection input, and a touch action comprising two static touch points can be interpreted as a back input. Thereby, by discriminating whether one or two touch points are present, i.e. if touch action is performed by one or two fingers, different instructions to the apparatus can be made without looking at the apparatus. Similarly, a sweeping movement touch point can be interpreted as a scroll input, where the scroll input can enable different items for selection, e.g. upon navigation in a menu structure. The touch sensitive input further can comprise a secondary surface, which in turn can comprise one or more sub-surfaces. For enabling interacting with the touch action user interface without looking at the apparatus, the one or more sub-surfaces each are preferably essentially perpendicular to the primary surface such that the user easily can feel the difference between the surfaces. This enables for the method to further comprise combinations of touch actions on different surfaces which can be interpreted accordingly, e.g. interpreting a touch action on the primary surface or any of the sub-surfaces, or a combination of touch actions on the primary surface and any of the sub-surfaces, or a combination of touch actions on at least two of the sub-surfaces according to the surface or surfaces of the touch action or actions, respectively. Another example can be interpreting a combination of touch actions on two of the sub-surfaces being arranged essentially in parallel, i.e. “squeezing” or “gripping” the apparatus, as for example a voice command activation input. Further an example is interpreting a touch action comprising a sweeping movement touch point on one of the sub-surfaces as a level setting input, such as audio volume, backlight intensity, or ringtone volume. Thus, one surface, e.g. the primary surface, can be arranged for selection of status, while another surface, e.g. one sub-surface of the secondary surface, can be arranged for input of a parameter for an item associated with the selected status. Thus, fairly complex input can be made without looking at the apparatus. The audio feedback can ensure for the user that the input becomes as intended.

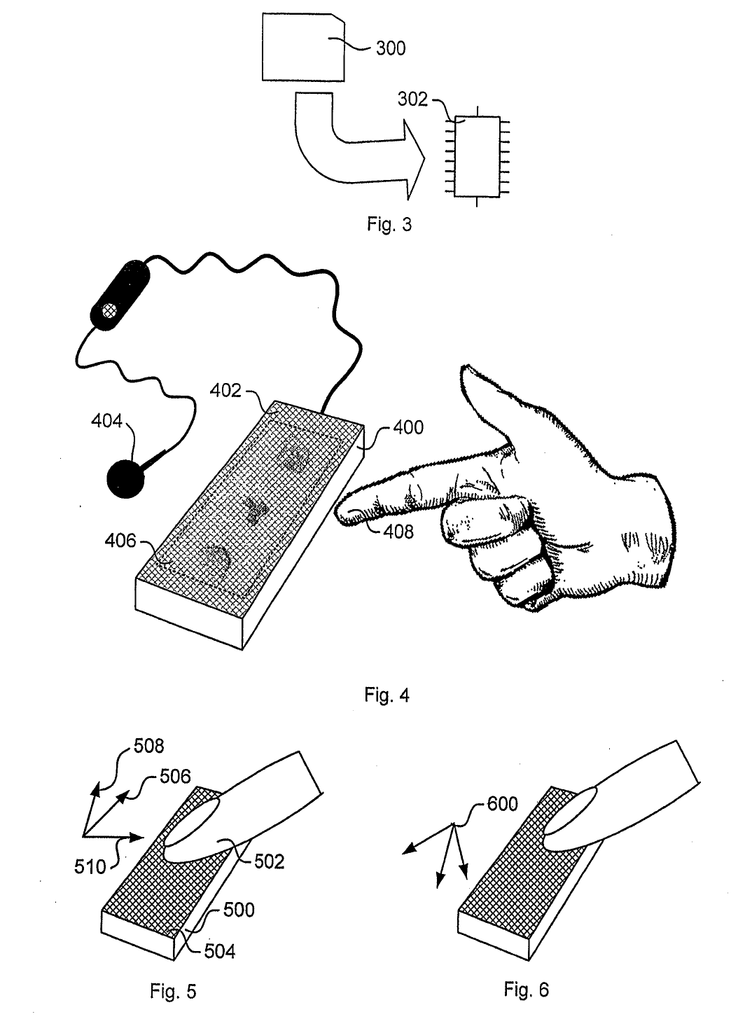

The embodiments of the method as demonstrated above are suitable for implementation with aid of processing means, such as the controller or CPU of the mobile communication apparatus. Therefore, there is provided computer programs, comprising instructions arranged to cause the processing means to perform the steps of any of the embodiments of the method described with reference to FIG. 2. The computer programs preferably comprise program code which is stored on a computer readable medium 300, as illustrated in FIG. 3, which can be loaded and executed by a processing means 302 of the mobile communication apparatus to cause it to perform the method according to any of the demonstrated embodiments. The processing means 302 and computer program product on the computer readable medium 300 can be arranged to execute the program code sequentially where actions of the any of the method are performed stepwise, but can also be arranged to perform the actions on a real-time basis, i.e. actions are performed upon request and/or available input data. The processing means 302 is preferably what normally is referred to as an embedded system. Thus, the depicted computer readable medium 300 and processing means 302 in FIG. 3 should be construed to be for illustrative purposes only to provide understanding of the principle, and not to be construed as any direct illustration of the elements.

FIG. 4 illustrates an example of a mobile communication apparatus 400 according to an embodiment. The apparatus 400 has a primary surface 402, here indicated as chequered, on which touch actions are receivable. The apparatus also has an audio interface 404, which here is a portable handsfree device. Behind the primary surface 402, a display 406 can be arranged. An optional feature is that the boundary of the display 406 is made essentially invisible to a user, although indicated in the drawing with a hashed line for the sake of understanding. To further enhance the image of the display boundary being invisible, content viewed on the display can be faded towards the boundary of the display 406. Thus, although the display area is smaller than the primary surface 402 of the apparatus 400, the user will not be confused in how to operate by touch actions or find the product distasteful. Thus, touch operations are possible also outside the boundary of the display. A user is enabled to operate the apparatus 400 by one or more fingers 408, and will receive audio feedback via the portable handsfree device 404, and will therefore be able to operate the apparatus without looking at it, or operate it and be able to look at the display.

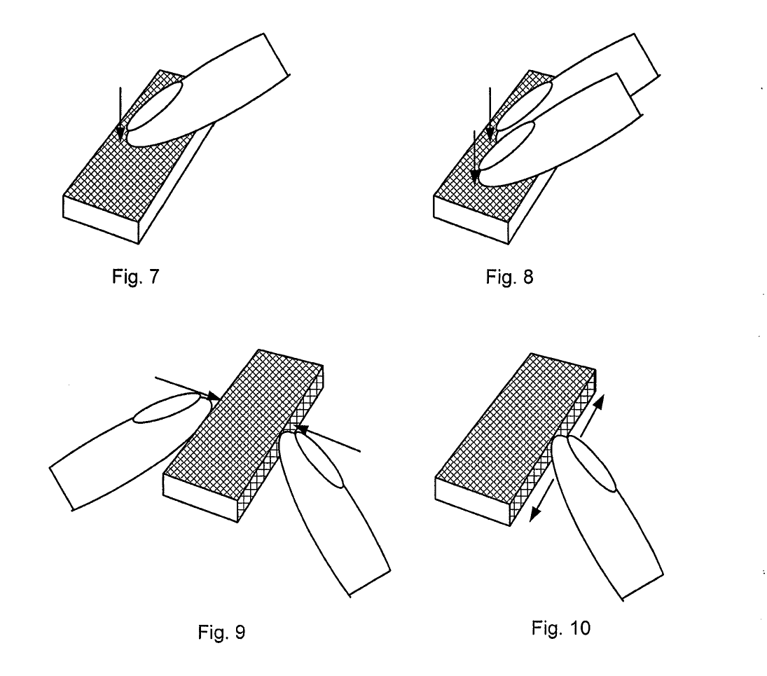

FIG. 5 schematically illustrates an apparatus 500, which can be similar to the one demonstrated with reference to FIG. 4. FIG. 5 also illustrates a touch action by a finger 502 on a touch area 504 of the apparatus 500. For a moving touch action made in a general direction, only relative positions are needed to detect the movement. The general direction can be divided into for example two general directions, wherein the plane of the surface is divided into directions accordingly. Other granularities of general directions are also possible, where the plane of the surface is divided into more general directions, e.g. three, four, six, eight or further general directions. In FIG. 5 one general direction can be as illustrated by arrow 506, while directions, as illustrated by exemplary arrows 508, 510, having at least a component in the general direction will be interpreted as a moving action in the general direction. Thus, a moving action in the other general direction, as illustrated in FIG. 6 by arrows 600 can be discriminated from the moving action as demonstrated with reference to FIG. 5. Similarly, a static touch action as illustrated in FIG. 7 where the finger is moved to a point on the surface, which can be any point, and then may be released from touch can be interpreted as a single point static touch action, and form basis for an instruction to the apparatus accordingly, e.g. as a selection input. FIG. 8 illustrates an alternative static touch action where two fingers are used, thus creating two touch points, which can be interpreted accordingly, e.g. as a back input for a menu navigation operation. FIG. 9 illustrates a further example of touch action where two opposite sub-surfaces of a secondary surface are actuated and enabling an interpretation accordingly, e.g. as an input for enabling a particular function such as voice control of the apparatus. FIG. 10 illustrates another example of touch action where a sub-surface of a secondary surface is used for setting for example a parameter, e.g. volume, brightness, dial, etc. The two general directions are here preferably interpreted as up/down, increase/decrease, yes/no, etc. respectively.

1. A mobile communication apparatus having a reduced user interface comprising
a touch sensitive input arranged to receive touch actions on a primary surface of the mobile communication apparatus, wherein interpretation of touch actions as input is independent on position of touch on the primary surface while being depending on the way of the touch action; and
an output arranged to provide an audio feedback of a user interface status from the interpreted input of the touch actions.

2. The apparatus according to claim 1, wherein the output further comprises a display, wherein the area of the primary surface for receiving touch actions is larger than an area of the display and covers the area of the display.

3. The apparatus according to claim 2, wherein the display is arranged such that, when in an off-state, the boundaries of the display area is essentially invisible on the surface of the mobile communication apparatus, and when in an on-state, content viewed on the display is faded towards the boundaries of the display such that the boundaries of the display area is hard to perceive.

4. The apparatus according to claim 2, wherein the display is arranged to, upon input of a touch action comprising a sweeping movement touch point to be interpreted as a scroll action, initially scroll content displayed on the screen in a direction opposite to the sweeping movement, and finally to scroll the content in a direction of the sweeping movement.

5. The apparatus according to claim 1, wherein a touch action comprising one static touch point is interpreted as a selection input, and a touch action comprising two static touch points is interpreted as a back input.

6. The apparatus according to claim 1, wherein a sweeping movement touch point is interpreted as a scroll input, and the scroll input enables different items for selection.

7. The apparatus according to claim 1, wherein the touch sensitive input further comprises a secondary surface comprising one or more sub-surfaces, wherein the one or more sub-surfaces each are essentially perpendicular to the primary surface, and wherein a touch action on the primary surface or any of the sub-surfaces, or a combination of touch actions on the primary surface and any of the sub-surfaces, or a combination of touch actions on at least two of the sub-surfaces are interpreted according to the surface or surfaces of the touch action or actions, respectively.

8. The apparatus according to claim 7, wherein a combination of touch actions on two of the sub-surfaces being arranged essentially in parallel is interpreted as a voice command activation input.

9. The apparatus according to claim 7, wherein a touch action comprising a sweeping movement touch point on one of the sub-surfaces to be interpreted as a level setting input, such as audio volume, backlight intensity, or ringtone volume.

10. The apparatus according to claim 1, wherein tactile input means of the apparatus consists of the touch sensitive input.

11. A method for a reduced user interface for a mobile communication apparatus, the method comprising
receiving at least one touch action on a primary surface of the mobile communication apparatus by a touch sensitive input;
interpreting the at least one touch action independent on position of touch on the primary surface while depending on the way of the at least one touch action; and
providing an audio feedback of a user interface status from the interpreted input of the at least one touch action.

12. The method according to claim 11, wherein a touch action comprising one static touch point is interpreted as a selection input, and a touch action comprising two static touch points is interpreted as a back input.

13. The method according to claim 11, wherein a sweeping movement touch point is interpreted as a scroll input, and the scroll input enables different items for selection.

14. The method according to claim 11, wherein the touch sensitive input further comprises a secondary surface comprising one or more sub-surfaces, wherein the one or more sub-surfaces each are essentially perpendicular to the primary surface, the method further comprising
interpreting a touch action on the primary surface or any of the sub-surfaces, or a combination of touch actions on the primary surface and any of the sub-surfaces, or a combination of touch actions on at least two of the sub-surfaces according to the surface or surfaces of the touch action or actions, respectively.

15. The method according to claim 14, further comprising interpreting a combination of touch actions on two of the sub-surfaces being arranged essentially in parallel as a voice command activation input.

16. The method according to claim 14, further comprising interpreting a touch action comprising a sweeping movement touch point on one of the sub-surfaces as a level setting input, such as audio volume, backlight intensity, or ringtone volume.

17. A computer readable medium comprising program code with instructions arranged to be executed by a processor of a mobile communication apparatus, wherein the instructions cause the mobile communication apparatus to perform the method according to claim 11.
